(19) United States
(12) Patent Application Publication
(10) Pub. No.: US 2025/0333568 A1
(43) Pub. Date: Oct. 30, 2025

(54) Upcycling Plastics toward 3D-printable Bioinspired Functional Organic-Inorganic Dynamic Polymer Network with Hierarchical Dynamic Bonds

(71) Applicant: UNM RAINFOREST INNOVATIONS, Albuquerque, NM (US)

(72) Inventor: Sungjin KIM, Albuquerque, NM (US)

(73) Assignee: UNM RAINFOREST INNOVATIONS, Albuquerque, NM (US)

(21) Appl. No.: 19/189,604

(22) Filed: Apr. 25, 2025

Related U.S. Application Data
(60) Provisional application No. 63/638,965, filed on Apr. 26, 2024.

(51) Int. Cl. C08J 3/24; B33Y 70/00

(52) U.S. Cl. CPC C08J 3/242; B33Y 70/00; C08J 2300/30

(57) ABSTRACT

A printable composition and a method of fabricating a material includes adding one or more ligands to a polymer. The method also includes incorporating a plurality of dynamic crosslinks into the polymer, and incorporating the dynamic polymer into a reprocessed material. Implementations of the method of fabricating a material may include reacting a metal with the one or more ligands to form a mineralized polymer. The metal may include iron. The mineralized polymer may include iron oxide. The method of fabricating a material may include providing an external stimulus to the mineralized polymer. The external stimulus may include an elevated temperature, pH, a magnetic field, or a combination thereof. The polymer may include acrylonitrile butadiene styrene, polybutadiene, polyisoprene, or a combination thereof. The ligand may include histidine. The ligand may include catechol.

### REFERENCE TO RELATED APPLICATIONS

This application claims the benefit of U.S. Provisional Patent Application No. 63/638,965, filed on Apr. 26, 2024, which is hereby incorporated by reference in its entirety.

### TECHNICAL FIELD

The present teachings relate generally to upcycled materials for three-dimensional printing and, more particularly, to processes and systems for converting plastics into materials for three-dimensional printing.

### BACKGROUND

Converting plastic waste into polymer with added values is a transformative recycling path to reduce carbon footprint. One promising approach involves transforming plastics into polymer networks with dynamic bonds. These bonds can break and reform reversibly, imparting properties akin to thermosets—mechanical strength, chemical stability, and thermal resilience—while retaining the processability, recyclability, and 3D printability of thermoplastics. While dynamic covalent crosslinking has been extensively researched in organic polymers, there has been limited exploration of incorporating both organic and inorganic resources into dynamic polymer networks. By harnessing the adaptability of dynamic crosslinks to various stimuli and integrating inorganic components, new avenues for repurposing plastic can be unlocked and inorganic waste can be incorporated into high-value smart polymers.

Plastics or polymers that are recyclable typically do not include thermoset materials, and instead commonly use thermoplastic materials, since they do not have crosslinks. While thermosets are more robust materials, they are not post-processable due to the crosslinked materials and instead are usually landfilled or incinerated.

Therefore, it is desirable to recycle and fabricate or synthesize new forms of polymers including designed polymer networks with hierarchical responses to multiple stimuli, such as heat, pH, and magnetic fields. Further reprocessing and 3D printing of these materials is also of particular utility.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of fabricating a material is disclosed. The method includes adding one or more ligands to a polymer. The method also includes incorporating a plurality of dynamic crosslinks into the polymer, and incorporating the dynamic polymer into a reprocessed material. Implementations of the method of fabricating a material may include reacting a metal with the one or more ligands to form a mineralized polymer. The metal may include iron. The mineralized polymer may include iron oxide. The method of fabricating a material may include providing an external stimulus to the mineralized polymer. The external stimulus may include an elevated temperature, pH, a magnetic field, or a combination thereof. The polymer may include acrylonitrile butadiene styrene, polybutadiene, polyisoprene, or a combination thereof. The ligand may include histidine. The ligand may include catechol. The method of fabricating a material may include injection molding the dynamic polymer to form a part may include the dynamic polymer. The method of fabricating a material may include forming a filament of the dynamic polymer, and extruding the filament through a three-dimensional printer to form a part may include the dynamic polymer.

A method of fabricating a dynamic polymer network is disclosed. The method includes incorporating a plurality of covalent bonds into a polymer, adding one or more ligands to the polymer, adding a metal or a metal oxide to react with the one or more ligands to form a mineralized polymer. The method also includes forming a part that can include the mineralized polymer.

A printable composition is disclosed. The printable composition includes a polymer network that includes a polymer, a plurality of dynamic crosslinks which may include covalent bonds incorporated into the polymer, and a plurality of ligands incorporated into the polymer. Implementations of the printable composition can include one or more inorganic components functionalized into the polymer network. The one or more inorganic components may include a metal or a metal oxide. The dynamic crosslinks are adaptively reconfigurable by one or more external stimuli. The one or more external stimuli may include changes in temperatures, pH, or magnetic field. The dynamic covalent bonds are configured to be reversibly broken and reformed. The printable composition may include a polyethylene glycol polymer. The plurality of ligands may include a catechol, histidine, or a combination thereof.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic illustration depicting an overview of a method for upcycling plastics toward three dimensional (3D) printable bioinspired functional organic-inorganic dynamic polymer network with hierarchical dynamic bonds, in accordance with the present disclosure.

FIG. 2 is a series of images depicting mussel-inspired polymer hydrogel networks binding various metals including those from critical/rare-earth minerals, in accordance with the present disclosure.

FIGS. 3A and 3B depict data associated with the magnetization of iron oxide grown at one or more metal-coordinating crosslinking sites of a mussel-inspired catecholic hydrogel and a demonstration of a magnetic response in a similar hydrogel, respectively, in accordance with the present disclosure.

FIGS. 4A-4E depicts examples of the upcycling of commodity plastics to a covalent adaptive network with dynamic covalent bonds using an ABS-vitrimer. FIG. 4A depicts a reaction scheme for modifying ABS with unsaturated double bonds using cysteamine to add amine moieties. FIG. 4B depicts a reaction scheme for the incorporation of dynamic imine bonds into the network, which are exchangeable at elevated temperatures above 150° C. FIG. 4C shows examples of the ABS-vitrimer (ALD-33) showing enhanced solvent resistance compared to neat ABS. FIG. 4D shows examples of the circular additive manufacturing of ABS-vitrimer in complex 3D shapes. FIG. 4E is a plot showing data representing enhanced compressive strength of ABS-vitrimer printed in forewing-inspired honeycomb structures, in accordance with the present disclosure.

FIG. 5 shows a chemical formula representation of an acrylate PEG succinimidyl propionate as a candidate precursor material that can be modified with mussel-inspired metal-coordinating ligands to function as a crosslinker molecule, in accordance with the present disclosure.

FIGS. 6A-6D depict dynamic metal-coordinate crosslinking paths of (FIG. 6A) mussel-inspired catechol or (FIG. 6B) histidine moieties tuned by pH, metal concentrations and metal-ligand types. FIG. 6C is a plot depicting rheological frequency sweep profiles of metal concentrations ([Fe]: [catechol]) and metal-ligand types (Fe-catechol vs. Ni-histidine). FIG. 6D is a plot depicting loss factor showing the energy-dissipative dynamic behavior of the metal-coordinate networks controlled by the aforementioned factors, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Converting plastic wastes into polymer with added values is a transformative recycling path to reduce the carbon footprint. Upcycling plastics into polymer networks crosslinked with dynamic bonds that can reversibly break and reform, endows mechanical-chemical-thermal robustness like thermosets while maintaining the processability, recyclability, and 3D-printability like thermoplastics. While such a strategy has been widely studied using dynamic covalent crosslinks majorly on organic polymers, utilizing both organic and inorganic resources to form an organic-inorganic dynamic network with hierarchical dynamic behaviors has been lacking. As described herein, if the dynamic crosslinks can adaptively reconfigure by multiple stimuli and be functionalized with inorganic components, such a path can suggest distinctive multidimensional tactics to valorize plastic wastes into high-value smart polymers. The present disclosure provides the design of dynamic polymer networks with hierarchical responses to multi-stimuli such as heat, pH, and magnetic fields. By chemically incorporating dynamic covalent bonds into discarded commodity plastics, a crosslinked network can be created that can be reprocessed and 3D-printed upon heating. Further, the present teachings provide the incorporation of mussel-inspired histidine or catecholic ligands that can form pH-triggered dynamic metal-coordinate crosslinks binding metals like irons into the above-formed dynamic covalent network. Such metal-coordinate crosslinks can induce in-situ mineralization forming iron oxide nanoparticles susceptible to magnetic actuation for healthcare, aerospace, and industrial applications. This approach offers a sustainable solution for transforming plastic waste into a smart polymer with enhanced properties, wide-ranging applications, and circular manufacturability.

The present disclosure provides designing polymer networks with hierarchical responses to multiple stimuli, such as heat, pH, and magnetic fields. Initially, the introduction of dynamic covalent bonds into discarded plastics can be accomplished, creating a crosslinked network that can be reprocessed and 3D printed at high temperatures. The incorporation of mussel-inspired histidine or catecholic ligands can form pH-triggered dynamic metal-coordinate crosslinks binding metals (e.g., transition metals or lanthanide ions or particulates found in rare earth/critical minerals) such as iron into the above-formed dynamic covalent network. These metal-coordinate crosslinks can break and reform at ambient temperature via binding or dissociating the metals upon pH change, thus offering processability at room temperatures that dynamic covalent bonds alone do not deliver. Such metal-coordinate crosslinks can also function as in-situ mineralization sites where metal ions and particles can nucleate and grow, which reinforce and functionalize the network. In examples, iron-coordinated catecholic hydrogels are susceptible to magnetic actuation for healthcare, aerospace, and robotic applications. This approach can provide a sustainable solution for transforming plastic and metallic wastes into a smart hybrid polymer with enhanced properties, wide-ranging applications, and circular manufacturability.

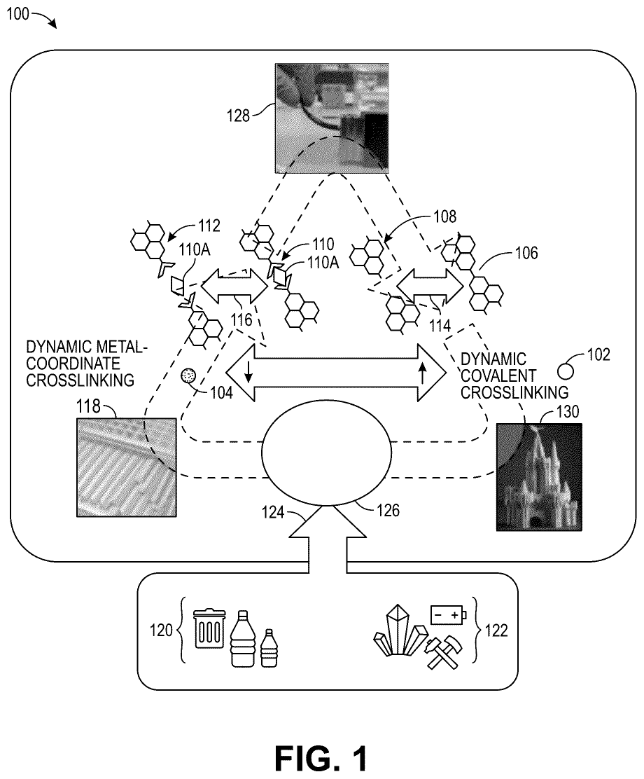

FIG. 1 is a schematic illustration depicting an overview of a method for upcycling plastics toward three dimensional (3D) printable bioinspired functional organic-inorganic dynamic polymer network with hierarchical dynamic bonds, in accordance with the present disclosure. A method of upcycling with the inclusion of fabricating a hierarchical dynamic polymer network 100 is shown. One general division of the method 100 shows the use of a polymer utilizing dynamic covalent crosslinking 102, with another general division showing a polymer utilizing dynamic metal-coordinate crosslinking 104. Within the use of a polymer utilizing dynamic covalent crosslinking 102, a first molecule including dynamic covalent crosslinking 106 is shown, where under an actuation via heat 114, the first molecule 106 is uncrosslinked into the first molecule in an uncrosslinked 108 state via the exposure to heat 114. Within the use of a polymer utilizing dynamic metal-coordinate crosslinking 104, a second molecule including dynamic metal-coordinate crosslinking 110 is shown, where a metal 110A is incorporated into the second molecule 110 to create a polymer having the capability to undergo dynamic metal-coordinate crosslinking 104. This second molecule can be rendered uncrosslinked 112 by actuation via pH 116. It should be noted that both the first molecule 106 and the second molecule 110 can undergo these crosslinkings and uncrosslinkings reversibly. By blending or fabricating these types of molecules, i.e., those undergoing either dynamic covalent crosslinking 102 or dynamic metal-coordinate crosslinking 104, into materials derived from either plastic waste 120 or inorganic waste 122, reinforced polymer composites 118 can be upcycled 124 to enter a value enhancing cycle 126 where such reinforced polymer composites 118 can be fabricated, for example, by 3D printing 130 to obtain enhanced properties, such as magnetic actuation 128.

In general, the present disclosure provides a method of fabricating a material, which includes adding one or more ligands to a polymer, incorporating a plurality of dynamic crosslinks into the polymer, and incorporating the dynamic polymer into a reprocessed material. The method can further include reacting a metal with the one or more ligands to form a mineralized polymer. The polymer can include acrylonitrile butadiene styrene (ABS), polybutadiene, polyisoprene, styrene-butadiene rubber (SBR), nitrile butadiene rubber (NBR), ethylene-propylene-diene monomer (EPDM), neoprene, or a combination thereof. In examples, the ligand can include histidine or catechol, or a combination thereof. Additional examples of catechols can include dopamine, pyrocatechol 3,4-dihydroxybenzoic acid, norepinephrine, epinephrine. Other illustrative examples of histidines can include L-histidine and histidine derivatives like methylated histidine. The metal reacted into the polymer can include iron, nickel cobalt, copper, zinc, terbium, or alloys or oxides thereof. The metal or inorganic material can further include combinations of the metals, alloys, or oxides. Further processing can include injection molding, forming a filament of the dynamic polymer, and extruding the filament through a three-dimensional printer to form a part comprising the dynamic polymer. Other plastic or polymer processing methods known to one skilled in the art can also be utilized. Providing an external stimulus to the mineralized polymer, such as an elevated temperature, pH, a magnetic field, or a combination thereof can also be employed in the method of fabricating a dynamic polymer network.

An alkene cross-coupling reaction or thiol-ene click reaction can be used to modify a variety of commodity plastics with unsaturated double bonds (for example, acrylonitrile butadiene styrene, polybutadienes, polyisoprene, etc.) to attach dynamic groups. Both the cross-coupling and thiol-ene click reactions are known for undemanding reaction conditions and high yield, thus these reactions can provide feasible and adequate modification paths to attach the dynamic crosslinkers to the plastic polymer backbone. First, the utilization of a dynamic covalent crosslinker containing dynamic disulfide bonds or imine bonds can endow the thermosets with reprocessability. Next, modification of short-chain polyethylene glycol polymers (sourced or synthesized) with unsaturated bonds and moieties to substitute with dynamic metal-coordinate ligands such as catechols or histidine can be utilized as dynamic noncovalent crosslinkers. These metal-coordinate crosslinkers can also be incorporated into the plastic backbone with double bonds. As such, the network will be equipped with both dynamic covalent bonds and dynamic metal-coordinate bonds that respond to different stimuli. By controlling crosslinker concentrations, conditions, and stimuli (e.g., temperature, metal types, pH), the control, and enhancement of chemical, thermomechanical, and rheological properties can be realized. These materials can be further optimized, along with their material properties, for use in selected (re) processing methods including extrusion, extrusion-based AM, or other processing methods. The evaluation of addition of inorganic particles and inorganic particle distribution and growth inside the network to be correlated and optimized using X-ray scattering and microscopy techniques. The molecular weight of inorganic particles and polymer network can be characterized using field flow fractionation equipped with triple detectors, such as multi angle light scattering (MALS), refractive index (RI), and ultraviolet (UV). In contrast to size exclusion chromatography, field flow fractionation is a column-free separation method that eliminates the risk of dissociation of metal-coordination bonds due to shear stress from column packing materials. Also, the charge of separated molecules can be measured using electrical field flow fractionation.

In examples of the present disclosure, the inorganic nanoparticles incorporated into the printable composition can be functionalized with organic ligands to enhance their properties and improve their compatibility with the polymer network or the hierarchical dynamic behaviors of the organic-inorganic dynamic network enable it to respond differently to different stimuli, such as temperature, pH, or magnetic fields, allowing for a wide range of applications in various industries. The reprocessed and 3D-printed structures formed of the materials described herein can be further modified by external stimuli, such as light or electricity, to activate additional functions or properties within the polymer network. The dynamic covalent bonds in the organic-inorganic dynamic network can be configured to respond to specific stimuli, allowing for the creation of structures with tailored properties and functionality. The use of dynamic metal-coordinate crosslinkers in printable or other plastic compositions allows for the incorporation of metals into the polymer network, which can enhance its mechanical properties and provide additional functionalities. The organic-inorganic dynamic network can further be used as a scaffold for the assembly of other materials or components, such as biomolecules or electronic devices, to create hybrid structures with interesting properties. The reprocessed and 3D-printed structures can be subjected to additional processing steps, such as surface treatment or coating, to improve their performance and functionality in specific applications. Furthermore, the organic-inorganic dynamic network can be configured to have multiple layers or regions with different properties, allowing for the creation of complex structures with tailored functionalities and performance characteristics, depending on the specific use or composition.

The present disclosure can provide a process, method, and several compositions directed towards the sustainable manufacturing of 3D-printable organic or organic-inorganic hybrid polymers with multi-hierarchical dynamic properties and multipath reprocessability along with functionalization toward high-value applications. A central aspect can include an understanding of the underlying mechanisms governing the dynamic behavior of these polymers under different stimuli and processing conditions, enabling precise control over their properties and applications. Based on this mechanistic understanding, the development of a 3D-printable, bioinspired organometallic polymer network capable of being reprocessed, reshaped, and repurposed by pH changes that break and reform an internal metal coordination at low, room temperatures and/or by thermal increment above the topology freezing temperature where the dynamic covalent bonds can rearrange themselves. These hierarchical dynamic behaviors enable the extrusion-based additive manufacturing (AM) such as fused filament fabrication (FFF), direct ink writing (DIW), and big-area AM (BAAM), or through conventional processing such as injection molding-casting, hot-pressing, and extrusion using selectable triggers such as pH or thermal conditions as mentioned above. Thus, the thermal, mechanical and chemical robustness of the original plastics can be enhanced to the level expected from thermosets owing to the crosslinks. This polymer can be thus applied as a more robust polymer matrix for reinforced polymer composites with glass fibers, carbon fibers, bioderived fibers, and inorganic components. Moreover, these polymers can be functionalized with inorganic nanoparticles utilizing the dynamic metal-coordinate bonding in the network via in-situ mineralization or external nanoparticle incorporation. Extending therefrom, the upcycling of inorganic ionic/particulate resources from critical or rare earth minerals can be directed into useful smart polymers. In such examples, inorganic components can work as crosslinkers that can reinforce, functionalize, and add low-temperature recyclability to the polymer network. This upcycling approach therefore provides paths that not only improve the polymer properties but also implement useful functions via inorganics. For example, iron ion/particulate-coordinated hydrogels can show magnetic actuation. Therefore, the present teachings offer upcycling strategies to transform plastic waste into high-value, stimuli-responsive dynamic networks with promising biomedical, robotic, automotive, or electronic applications achievable from different metal selections and functionalization.

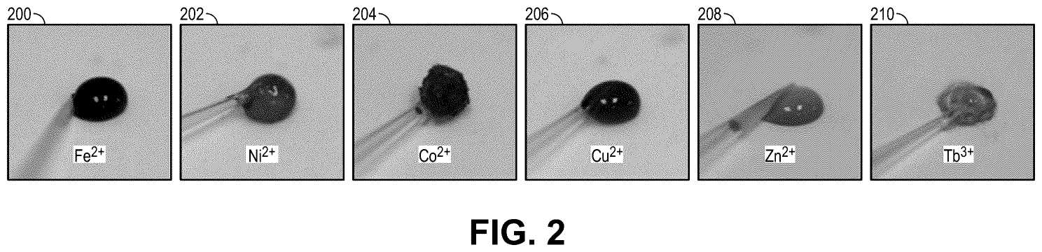

FIG. 2 is a series of images depicting mussel-inspired polymer hydrogel networks binding various metals including those from critical/rare-earth minerals, in accordance with the present disclosure. As shown in FIG. 2, the images show the initial polymer materials comprising various hydrogel network polymer materials including metals such as a hydrogel network including iron 200, a hydrogel network including nickel 202, a hydrogel network including cobalt 204, a hydrogel network including copper 206, a hydrogel network including zinc 208, and a hydrogel network including terbium 210. This variety of metal coordinated bonding in example materials can provide the incorporation of properties into polymers that provide actuation based on pH changes in a surrounding environment, or specific properties attributable to the metal incorporated into the metal-coordinate bonding of the polymer. The dynamic metal-coordinate bonds can provide advantages in terms of adaptive reconfiguration and functionalization with inorganic components. The incorporation of mussel-inspired histidine or catecholic ligands, which can form pH-triggered dynamic metal-coordinate crosslinks binding metals like iron, for example, into the dynamic covalent network, enables the formation of in-situ mineralized iron oxide nanoparticles susceptible to magnetic actuation for various applications. The use of different pH or thermal conditions can further allow for reprocessing and 3D-printing upon heating, enabling hierarchical dynamic behaviors that can be controlled to optimize material properties for specific applications in biomedical, robotic, automotive, or electronic industries. The polymer can include acrylonitrile butadiene styrene (ABS), polybutadiene, polyisoprene, styrene-butadiene rubber (SBR), nitrile butadiene rubber (NBR), ethylene-propylene-diene Monomer (EPDM), neoprene, or a combination thereof.

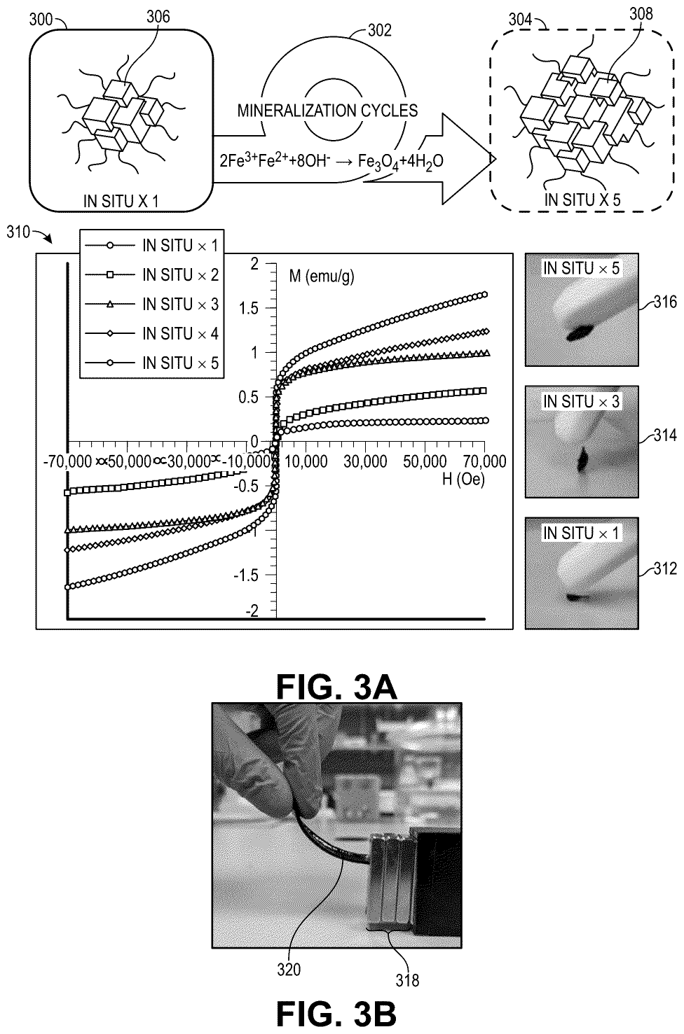

FIGS. 3A and 3B depict data associated with the magnetization of iron oxide grown at one or more metal-coordinate crosslinking sites of a mussel-inspired catecholic hydrogel and a demonstration of a magnetic response in a similar hydrogel, respectively, in accordance with the present disclosure. In a magnetization of a metal-coordinate crosslinked polymer in situ 300 the material after a first cycle 306, which includes a metal-coordinate crosslinked polymer is shown. This material after a first cycle 306 can undergo subsequent mineralization cycles 302, for example, following the equation shown below:

$$2 {Fe}^{3 +} + {Fe}^{2 +} + 80 {H}^{-} \to {Fe}_{3} {O}_{4} + 4 {H}_{2} O \qquad ( Eq . 1 )$$

The resulting material can be, for example, a material including a magnetization of a metal-coordinate crosslinked polymer after five times in situ 304, showing said material after a fifth cycle 308. Also shown in FIG. 3A is a plot showing qualitative magnetic responses to a magnetic field 310, specifically, with changes in the magnetic response after each magnetization iteration. The results of the described reaction include a material after magnetization in situ one time 312, magnetization in situ three times 314, and magnetization in situ five times 316. FIG. 3B shows a similar hydrogel containing iron oxide particles 320 grown in a mineralization reaction bath responding to magnets 318. For the in-situ mineralization and formation of iron oxide nanoparticles the creation of dynamic polymer networks with hierarchical responses to multi-stimuli such as magnetic fields can include a metal-coordinate crosslinker that can induce in-situ mineralization, forming iron oxide nanoparticles susceptible to magnetic actuation for healthcare, aerospace, and industrial applications. The iron oxide nanoparticles are formed through a chemical reaction between the dynamic metal-coordinate crosslinkers and metals like iron, resulting in the formation of stable nanoparticles within the polymer network. These crosslinkers are configured to bind metals like iron, which can then undergo a chemical reaction and form stable iron oxide nanoparticles within the polymer matrix. The formation of these nanoparticles is induced by the pH-triggered dynamic metal-coordinate crosslinks, which are formed as a result of the incorporation of mussel-inspired histidine or catecholic ligands into the polymer network, The polymer can include acrylonitrile butadiene styrene (ABS), polybutadiene, polyisoprene, styrene-butadiene rubber (SBR), nitrile butadiene rubber (NBR), ethylene-propylene-diene Monomer (EPDM), neoprene, or a combination thereof.

The iron oxide nanoparticles formed through in-situ mineralization exhibit properties that make them suitable for magnetic actuation. The size and shape of these nanoparticles can be controlled by adjusting the reaction conditions and stimuli used during the formation process. This allows for the tailoring of the properties of the nanoparticles to meet specific requirements for different applications in healthcare, aerospace, and industrial sectors. The iron oxide nanoparticles formed through in-situ mineralization can be further functionalized with organic or inorganic components to enhance their properties and suitability for various applications. For instance, they can be doped with other metals like nickel or copper to alter their magnetic properties or used as contrast agents in medical imaging. In the aerospace industry, iron oxide nanoparticles can be used as catalysts for fuel cells or as sensors for detecting gases and pollutants. In industrial applications, they can act as catalysts for chemical reactions or as magnetic cooling materials.

The process of in-situ mineralization offers several advantages over external nanoparticle incorporation methods. First, it enables the formation of nanoparticles within the polymer network itself, rather than on its surface, which can lead to improved mechanical strength and stability. Second, it allows for the control of the size, shape, and distribution of the nanoparticles by adjusting the reaction conditions and stimuli used during the formation process. Finally, it eliminates the need for additional processing steps typically required in external nanoparticle incorporation methods, simplifying the overall manufacturing process.

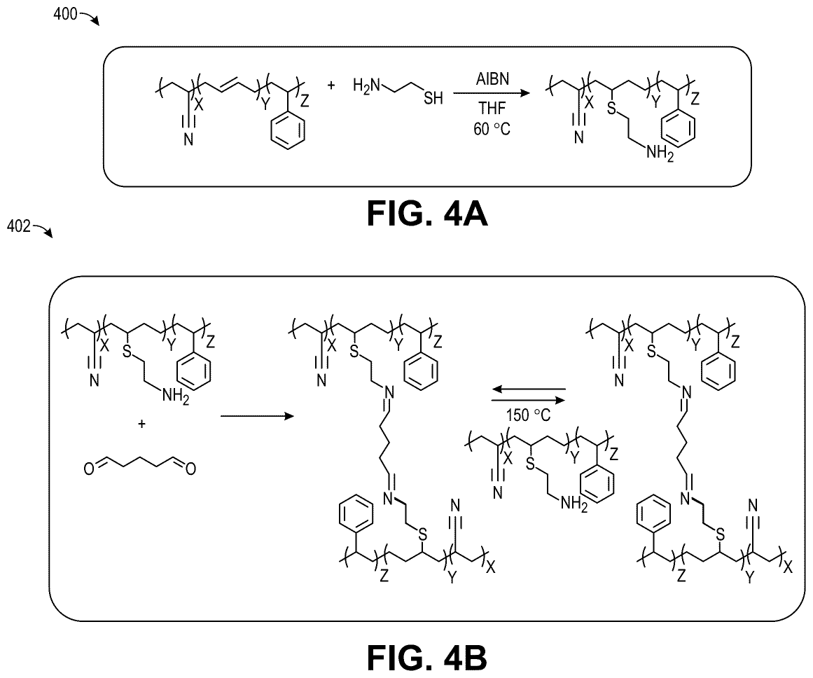

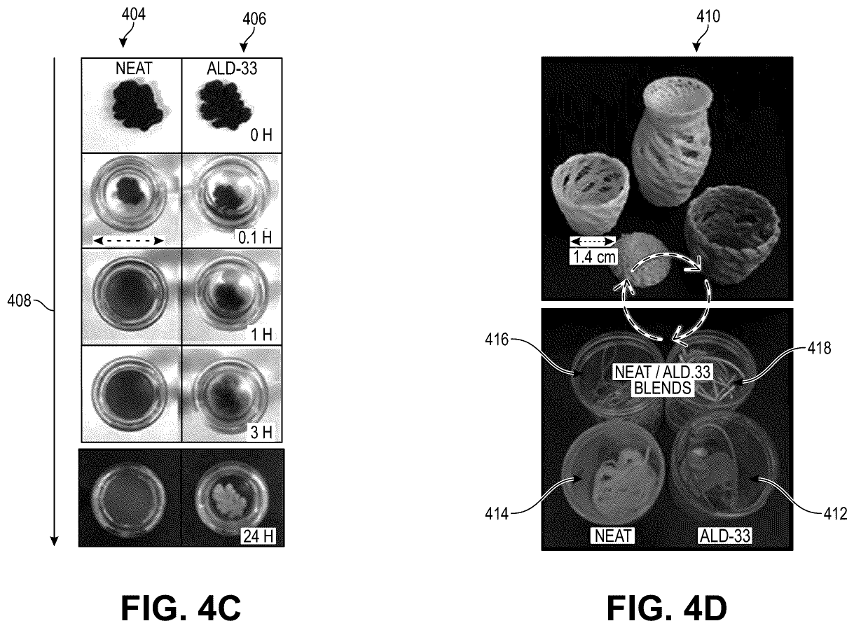

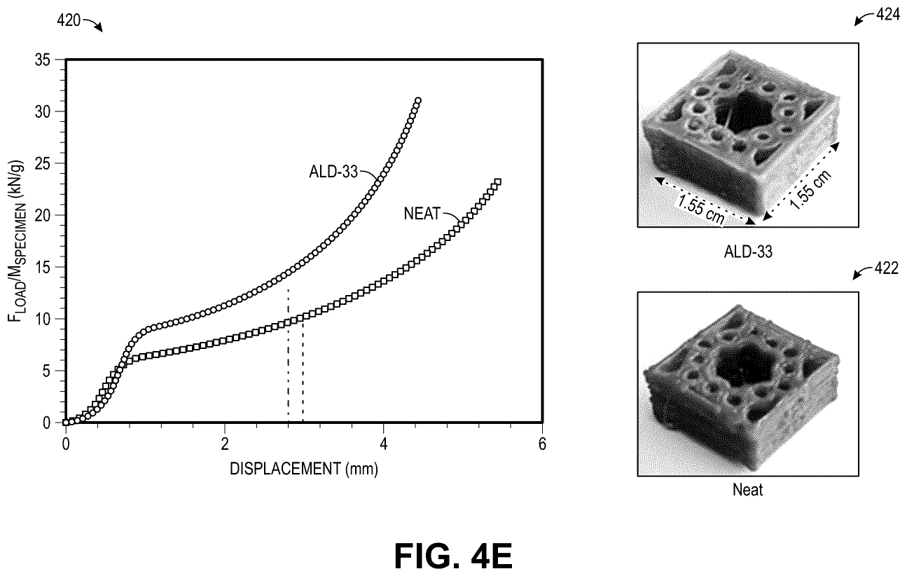

FIGS. 4A-4E depicts examples of the upcycling of commodity plastics to a covalent adaptive network with dynamic covalent bonds using an ABS-vitrimer. FIG. 4A depicts a reaction scheme for modifying ABS with unsaturated double bonds using cysteamine to add amine moieties. In the thiol-ene reaction 400 shown, the unsaturated double bonds in the acrylonitrile butadiene styrene (ABS) are modified with cysteamine to add amine moieties in tetrahydrofuran (THF) solution, with azobisisobutyronitrile (AIBN) as the radical initiator in a reaction completed at 60° C. FIG. 4B depicts a reaction scheme for the incorporation of dynamic imine bonds into the network, which are exchangeable at elevated temperatures above 150° C. In the dynamic imine formation/exchange reaction 402 shown, dynamic imine bonds which are exchangeable at elevated temperatures >150° C. are introduced to the network. FIG. 4C shows examples of the ABS-vitrimer (ALD-33) showing enhanced solvent resistance compared to neat ABS. A column of neat polymer samples 404 and a column of modified (ALD-33) polymer samples including ABS-vitrimer samples 406 are shown after increasing immersion time in a solvent 408, which can include THF, dichloromethane (DCM), dimethylformamide (DMF). The ABS-vitrimer (ALD-33) exhibits enhanced solvent resistance compared to the neat ABS. FIG. 4D shows examples of the circular additive manufacturing of ABS-vitrimer in complex 3D shapes. A variety of objects and materials are shown in product form 410 in a complex 3D shape with ALD-33 ABS-vitrimer samples 412, neat polymer samples 414, a first neat/ALD-33 blend 416, and a second neat/ALD-33 blend 418 are shown. FIG. 4E is a plot showing data representing enhanced compressive strength of ABS-vitrimer printed in forewing-inspired honeycomb structures, in accordance with the present disclosure. The plot showing enhanced compressive strength of ABS-vitrimer 420 as compared to the neat ABS is shown along examples of 3D-printed honeycomb structure of neat polymer 422; and the ALD-33 ABS-vitrimer sample 424.

The incorporation of dynamic covalent crosslinking units such as disulfide bonds or imine bonds can endow the crosslinked polymer network with reprocessability, as described previously. By controlling concentrations of crosslinkers and metals, and external stimuli such as, but not limited to temperature, metal types, or pH, the fundamental mechanism to control and enhance chemical, thermal, mechanical, and rheological properties and behaviors can be realized. For these assessments, rheometry, dynamic mechanical analysis (DMA), thermogravimetric analysis (TGA), mechanical tensile testing can be used. Dependent on these measurements, material properties for selected (re) processing methods including extrusion, extrusion-based A M, or other processing methods can be optimized.

Reprocessing and 3D printing of the crosslinked network upon heating is a viable concept in transforming plastic waste into high-value smart polymers with enhanced properties and wide-ranging applications. By controlling the concentration and conditions of dynamic crosslinkers, the alkene cross-coupling reaction or thiol-ene click reaction can be employed to modify commodity plastics with unsaturated double bonds. These modifications introduce dynamic groups that enable the attachment of dynamic crosslinkers to the polymer backbone, resulting in a thermoset with reprocessability.

The reprocessed and 3D-printed structures can further be functionalized with inorganic nanoparticles using the dynamic metal-coordinate bonding in the network via in-situ mineralization or external nanoparticle incorporation. Incorporating the aforementioned mussel-inspired histidine or catecholic ligands that form pH-triggered dynamic metal-coordinate crosslinks binding metals like iron into the above-formed dynamic covalent network allows for the formation of inorganic nanoparticles susceptible to magnetic actuation, among other properties. These dynamic polymer networks with hierarchical responses to multi-stimuli such as heat, pH, and magnetic fields can enable enhanced and controllable physical properties.

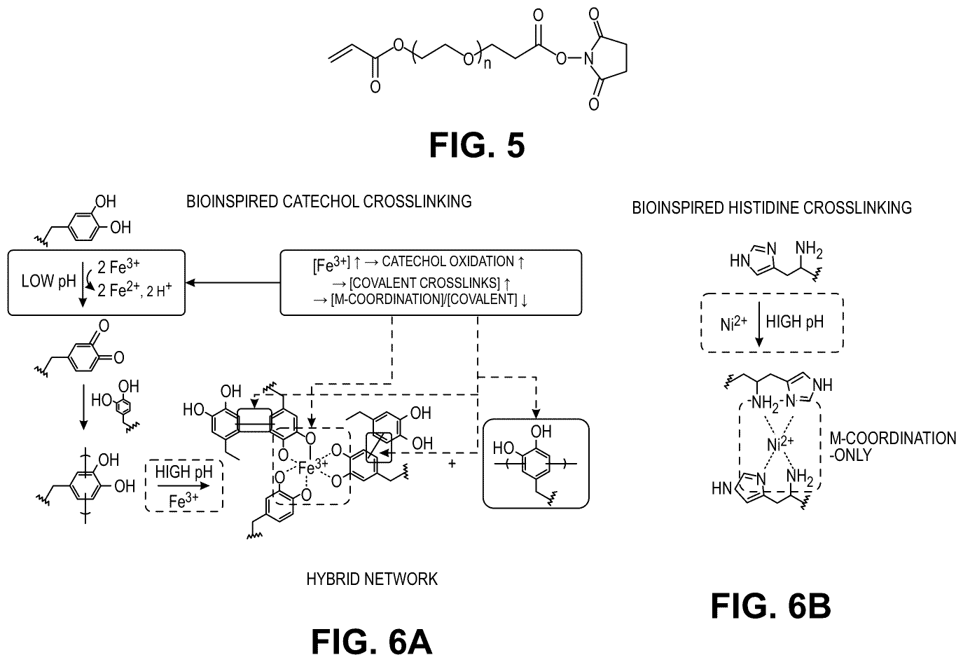

FIG. 5 shows a chemical formula representation of an acrylate PEG succinimidyl propionate as a candidate precursor material that can be modified with the aforementioned mussel-inspired metal-coordinating ligands to function as a crosslinker molecule, in accordance with the present disclosure. Such a starting material can be incorporated into one or more of the previously described reactions or processing steps to create dynamic polymer materials that either include dynamic covalent crosslinking or dynamic metal-coordinate crosslinking in response to thermal or other state changes that can modify the materials or the structures into which the aforementioned materials are incorporated. In other examples, acrylate PEG succinimidyl carboxymethyl ester can be also used.

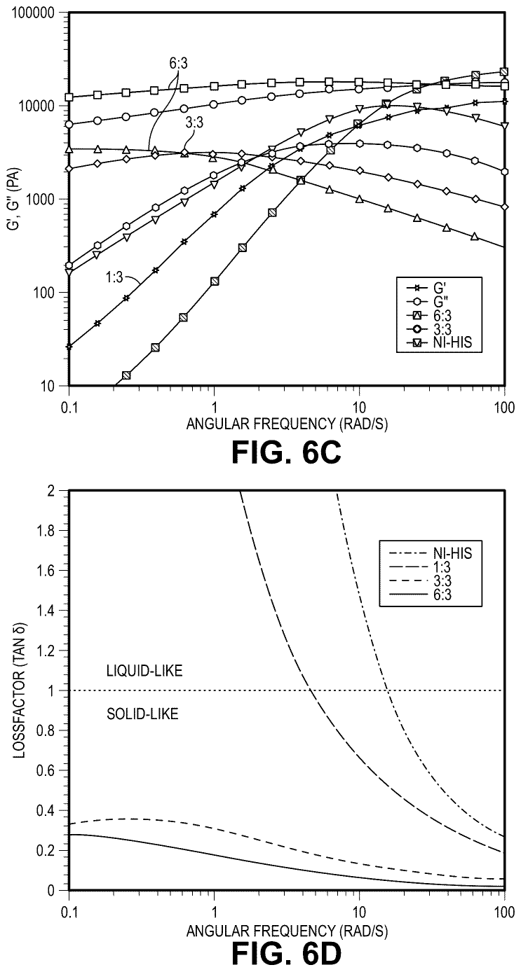

FIGS. 6A-6D depict dynamic metal-coordinate crosslinking paths of (FIG. 6A) mussel-inspired catechol or (FIG. 6B) histidine moieties tuned by pH, metal concentrations and metal-ligand types. FIG. 6C is a plot depicting rheological frequency sweep profiles of metal concentrations ([Fe]: [catechol]) and metal-ligand types (Fe-catechol vs. Ni-histidine). FIG. 6D is a plot depicting loss factor showing the energy-dissipative dynamic behavior of the metal-coordinate networks controlled by the aforementioned factors, in accordance with the present disclosure. In examples of the present disclosure, mussel-inspired histidine or catecholic ligands are incorporated into the polymer network to form pH-triggered dynamic metal-coordinate crosslinks. These specific ligands offer an approach to upcycling plastic waste by utilizing both organic and inorganic resources to create an organic-inorganic dynamic network with hierarchical dynamic behaviors. By incorporating these ligands, the resulting polymer network can be functionalized with inorganic nanoparticles that are responsive to pH changes, allowing for the formation of iron oxide nanoparticles susceptible to magnetic actuation, or other metal or metal oxide nanoparticles, or combinations thereof. FIG. 6A shows a reaction scheme of incorporating mussel-inspired catechol ligands to create dynamic metal-coordinate crosslinking paths into polymeric networks. In the Fe-catechol networks, it is known that Fe3+ ions form tris-Fe-catechol coordination complexes at basic pH (>8.5), while the excess Fe3+ ions are also known to oxidize catechols to induce covalent dicatechol cross-linking under the initially acidic pH before the pH jump for Fe coordination. Thus, by adjusting the concentration of Fe3+ mixed with 4cPEG (e.g., [Fe]/[catechol]=1:3, 3:3, 6:3), the fractions of permanent covalent and dynamic metal-coordinate cross-links can be controlled in the resulting covalent/metal-coordinate hybrid networks. FIG. 6B shows a reaction scheme of incorporating histidine moieties tuned by pH, metal concentrations and metal-ligand types into polymeric networks.

The process of incorporating mussel-inspired histidine or catecholic ligands into the polymer network further includes modifying short-chain polyethylene glycol polymers with unsaturated bonds and moieties, which can then be substituted with dynamic metal-coordinate ligands such as catechols or histidine. These specific ligands are chosen for their ability to form pH-triggered dynamic metal-coordinate crosslinks that bind metals like iron into the dynamic covalent network. By controlling the concentration and conditions of these ligands, the control, and enhancement of chemical, thermomechanical, and rheological properties of the resulting polymer network can be obtained. The formation of in-situ mineralized iron oxide nanoparticles within the polymer network upon pH changes. These nanoparticles are responsive to magnetic actuation, where the specific properties of these nanoparticles can be tailored by selecting appropriate metal types and stimuli used during the incorporation process.

FIG. 6C is a plot depicting rheological frequency sweep profiles of metal concentrations ([Fe]: [catechol]) and metal-ligand types (Fe-catechol vs. Ni-histidine). The G′ (G-prime) or the storage modulus and the G″ (G-double prime) or the loss modulus are shown as a function of angular frequency. For example, the storage modulus of the various compositions changes with concentration of the metal in the composition or as a result of the metal-ligand type. For example, the data in FIG. 6C illustrates that increasing the Fe3+ concentration in the starting formulation increases the covalent crosslinking prior to dynamic Fe-catechol coordination crosslinking, resulting in overall solid-like behavior represented by high G′ longer time scale (i.e., wider frequency range). The type of metal-ligand interaction also significantly affects the moduli. For example, Fe-catechol complexes might exhibit different stiffness compared to Ni-histidine complexes due to variations in coordination strength and geometry. This controllability of mechanical responses, represented by G′, allows tuning of the solid-like properties (i.e., stiffness) in the short- and long-term time scales. This is crucial for applications requiring specific mechanical properties, such as structural components or flexible actuators. The G″ represents the viscous component, affecting the material's ability to dissipate energy, which influences damping behavior and processability, such as flow during 3D printing. Fine-tuning both G′ and G″ enables the design of materials with tailored viscoelastic behavior for specific processing and application requirements.

FIG. 6D plot depicting loss factor (tan 8) showing the energy-dissipative dynamic behavior of the metal-coordinate networks controlled by the aforementioned factors as a function of angular frequency. Since tan 8 is defined as G′/G″, the previous statements relative to FIG. 6C also translate to this trend accordingly. Changes in composition, such as metal concentration and metal-ligand type, alter the tan 8 values. A higher tan & suggests more energy dissipation, indicating a more liquid-like, energy-absorbing material, while a lower tan & indicates a more elastic, solid-like material. The implications for processability are significant. A higher tan 8 might be desirable for applications requiring damping or energy absorption, such as in shock absorbers or vibration dampeners. Conversely, a lower tan & could be beneficial for structural applications where stiffness and elasticity are paramount. In terms of processability, a balanced tan 8 is often ideal for 3D printing, allowing the material to flow sufficiently during printing while maintaining enough structural integrity to hold its shape. The ability to control tan 8 through metal concentration and ligand choice enables the design of materials optimized for specific processing techniques and functional applications.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of fabricating a material, comprising:
adding one or more ligands to a polymer;
incorporating a plurality of dynamic crosslinks into the polymer; and
incorporating the dynamic polymer into a reprocessed material.

2. The method of fabricating a material of claim 1, further comprising reacting a metal with the one or more ligands to form a mineralized polymer.

3. The method of fabricating a material of claim 1, wherein the polymer comprises acrylonitrile butadiene styrene, polybutadiene, polyisoprene, or a combination thereof.

4. The method of fabricating a material of claim 1, wherein the ligand comprises histidine.

5. The method of fabricating a material of claim 1, wherein the ligand comprises catechol.

6. The method of fabricating a material of claim 2, wherein the metal comprises iron.

7. The method of fabricating a material of claim 2, wherein the mineralized polymer comprises iron oxide.

8. The method of fabricating a material of claim 1, further comprising injection molding the dynamic polymer to form a part comprising the dynamic polymer.

9. The method of fabricating a material of claim 1, further comprising:
forming a filament of the dynamic polymer; and
extruding the filament through a three-dimensional printer to form a part comprising the dynamic polymer.

10. The method of fabricating a material of claim 2, further comprising providing an external stimulus to the mineralized polymer.

11. The method of fabricating a material of claim 10, wherein the external stimulus comprises an elevated temperature, pH, a magnetic field, or a combination thereof.

12. A method of fabricating a dynamic polymer network, comprising:
incorporating a plurality of covalent bonds into a polymer;
adding one or more ligands to the polymer;
adding a metal or a metal oxide to react with the one or more ligands to form a mineralized polymer; and
forming a part comprising the mineralized polymer.

13. A printable composition, comprising:
a polymer network, comprising:
a polymer, a plurality of dynamic crosslinks comprising covalent bonds incorporated into the polymer, and a plurality of ligands incorporated into the polymer.

14. The printable composition of claim 13, further comprising one or more inorganic components functionalized into the polymer network.

15. The printable composition of claim 13, wherein the dynamic crosslinks are adaptively reconfigurable by one or more external stimuli.

16. The printable composition of claim 13, wherein the dynamic covalent bonds are configured to be reversibly broken and reformed.

17. The printable composition of claim 15, wherein the one or more external stimuli comprise changes in temperatures, pH, or magnetic field.

18. The printable composition of claim 14, wherein the one or more inorganic components comprise a metal or a metal oxide.

19. The printable composition of claim 13, further comprising a polyethylene glycol polymer.

20. The printable composition of claim 13, wherein the plurality of ligands comprises a catechol, histidine, or a combination thereof.
